(19) United States
(12) Patent Application Publication
(10) Pub. No.: US 2020/0237485 A1
(43) Pub. Date: Jul. 30, 2020

(54) Dental Restoration Maintenance Apparatus and Method

(71) Applicant: PDT, Inc., Missoula, MT (US)

(72) Inventors: Alfonso F. Pineyro, Bothell, WA (US); Linda J. Miller, Missoula, MT (US)

(73) Assignee: PDT, Inc., Missoula, MT (US)

(21) Appl. No.: 16/775,566

(22) Filed: Jan. 29, 2020

Related U.S. Application Data
(60) Provisional application No. 62/798,886, filed on Jan. 30, 2019.

(51) Int. Cl. A61C 8/00; A61C 17/00

(52) U.S. Cl. CPC A61C 8/0056; A61C 17/00

(57) ABSTRACT

A set of instruments with portions shaped and sized to engage specific portions of a dental implant is provided. Each of the instruments includes a tip on an end of a shank, the tip including an arcuate portion transverse to a longitudinal axis of the end of the shank. The arcuate tip portion may be crescent or hook shaped.

### STATEMENT REGARDING FEDERALLY SPONSORED RESEARCH OR DEVELOPMENT

(Not Applicable)

### BACKGROUND

Dental restorations have been successfully used for a number of years to replace or restore an individual's dentures or natural teeth. In full-arch implant restorations, an entire group of upper or lower teeth or dentures are replaced with a prosthesis that is anchored to the bone of the associated upper or lower jaw. The anchoring mechanism includes implants that provide a rigid connection between the prosthesis and the bone.

Dental plaque is a biofilm or mass of bacteria that grows on surfaces within the mouth and tends to form into a harder dental tartar or calculus on teeth. Progression and build-up of dental plaque can give rise to tooth and/or periodontal problems such as gingivitis and periodontitis, which can lead to bone loss. Removal of dental plaque is usually achieved with tooth brushing, flossing and/or interdental brushes. Dental tartar is usually removed through professional cleaning, since techniques for removing dental plaque are often not suitable for removal of dental tartar. Professional cleaning involves the use of special instruments that are useful for removing dental tartar in places that are sometimes challenging to reach otherwise. For example, special dental tartar removal instruments are configured with angled shafts that can more easily access surfaces on inward sides of teeth.

Dental tartar can form on dental restorations, including the above-mentioned implants and prosthesis. The implants, abutments, as well as the framework of the prosthesis are often constructed of titanium or zirconium.

### SUMMARY

Discussed herein are various examples of a dental instrument for the maintenance of dental implant restorations or devices, including full-arch dental implant restorations. In some examples the instrument has a particularly shaped and sized surface for engaging and cleaning surfaces of the implant. Several example instruments, separately or in combination, are useful for accessing and/or cleaning certain areas of the implant, including buccal, lingual, anterior, and posterior access, as well as mesial or distal access to engage implant surfaces. Some example instruments are suitable for accessing and cleaning a prosthesis that is supported by the implant.

Regular maintenance of dental implants and their restorations is recommended and it is an important feature in the longevity of this treatment modality. Implants can be used to replace a single tooth or multiple missing teeth. This replacement is done by fabricating implant supported crowns and bridges. Implants may also be used to restore a complete arch of missing teeth and this option is becoming a popular treatment choice in certain circumstances. Due to the use of multiple implants, these full arch cases can be provisionalized the same day. In many cases, patients that have a failing dentition can also receive a restoration that is implant-supported the same day as the dental extractions are completed. This treatment schedule makes this option very appealing to patients suffering from dental pain, poor self-esteem and poor chewing function. These restorations are screw-retained and regular maintenance is recommended. The numerous types of implant systems, e.g., for single crown implants, single tooth implants, Locator system implants, partial or full arch implants, all have comparable abutment structures for which regular maintenance, for example cleaning, is recommended. The radius of curvature of the outer surface of these abutment structures is comparable over a number of manufacturers and modes.

Multiple implant hygiene instruments and techniques are currently available. For example, floss, interdental brushes and Waterpiks can be used to help remove plaque from implants, sometimes with limited efficacy. Dental instruments for implant hygiene are usually available in two material types, hard plastic or titanium and the designs are derived from previously designed hygiene instruments. These instruments sometimes are shaped and sized to follow the design of instruments that were intended for hygiene on natural teeth. The anatomy of teeth and dental implants is quite different. Teeth have root furcations, cementoenamel junctions, anatomical concavities and convexities. Implants often do not have these features found in natural teeth. The instruments designed for natural teeth hygiene are less utile for performing hygiene functions on implants and restorations. The instruments discussed herein are designed and developed for hygiene of implants and restorations, including full-arch implant restorations.

In some examples, the tip of the instrument includes a curved surface that matches a curved surface of an abutment used to support the restoration. The curved surface of the tip may be an arc, which may be circular, parabolic or any other curvature that matches a curvature aspect of the abutment. For example, the abutment may have a specified radius of curvature that the tip of the instrument matches to permit engagement between the curved surface of the instrument tip and the abutment surface. In some examples the curvature of the tip is concave to match a convex abutment. In some examples, the curvature of the tip is larger than that of the abutment, which can contribute to engagement between the tip and abutment when presented at an angle to each other. For example, the tip can engage with the abutment at an angle such that the plane defined by the curved tip is nonparallel with an orthogonal of the curved surface of the abutment, such as when the instrument is angled upwardly or downwardly in its approach to the abutment. As another example, a larger curvature radius for the tip can be useful if the tip is twisted by the user to bring a majority of the tip into contact with the abutment during cleaning. In general, the tips of the instruments discussed herein can be configured to accommodate any size, shape or mode of implant and/or abutment and/or prosthesis desired to provide enhanced and effective cleaning opportunities and implementations.

In some examples, the tip design permits a larger surface contact area with the abutment than is possible with prior instruments, making plaque and calculus removal more efficient and productive, leading to enhanced hygiene results. The instrument tip is mounted to a shaft that can be angled in different directions. In some examples, the tip and/or shank is designed to fit under the prosthesis, e.g., between the prosthesis and the patient's gum, to permit access to hard to reach areas. Some examples have an angled shank to permit the tip to be presented from a posterior side of the implant when accessed via the mouth of the patient. One advantage of these configurations is that the prosthesis can remain in place during cleaning and maintenance operations. Having the prosthesis remain in place reduces costs, since the screws that fasten the prosthesis to the abutment are relatively expensive, and may be replaced with new screws each time they are removed. The reduced cost and complexity of hygiene maintenance tends to lead to better patient compliance and improved long term results.

### BRIEF DESCRIPTION OF THE SEVERAL VIEWS OF THE DRAWINGS

The disclosure is described in greater detail below, with reference to the accompanying drawings, in which:

FIG. 1 is a front isometric view of six implants and a mating prosthesis;

FIG. 2 is a photograph of abutments covered with plaque;

FIG. 3 is a top plan view of a first example instrument;

FIG. 3a is an isometric view of one end of the first example instrument;

FIG. 4 is a top plan view of a second example instrument;

FIG. 4a is an isometric view of one end of the second example instrument;

FIG. 4b is an isometric view of the end of the second example instrument in FIG. 4a as seen looking straight into the curvature of the tip;

FIG. 5 is a top plan view of a third example instrument;

FIG. 5a is an isometric view of one end of the third example instrument;

FIG. 6 is a top plan view of a fourth example instrument;

FIG. 7 is a partial top plan view of an instrument tip;

FIG. 7a is an end view of an instrument tip;

FIG. 8 is a photograph of an instrument tip engaged with an abutment;

FIG. 9 is a photograph of an instrument engaged with a lip of a prosthesis;

FIG. 10 is a photograph of an instrument engaged with a coping in a prosthesis;

FIGS. 11 and 12 are perspective views of a tip of a current hygiene tool next to a tip of the fourth example instrument; and

FIG. 13 is a perspective view of a tip of a current hygiene tool next to a tip of the second example instrument.

### DETAILED DESCRIPTION

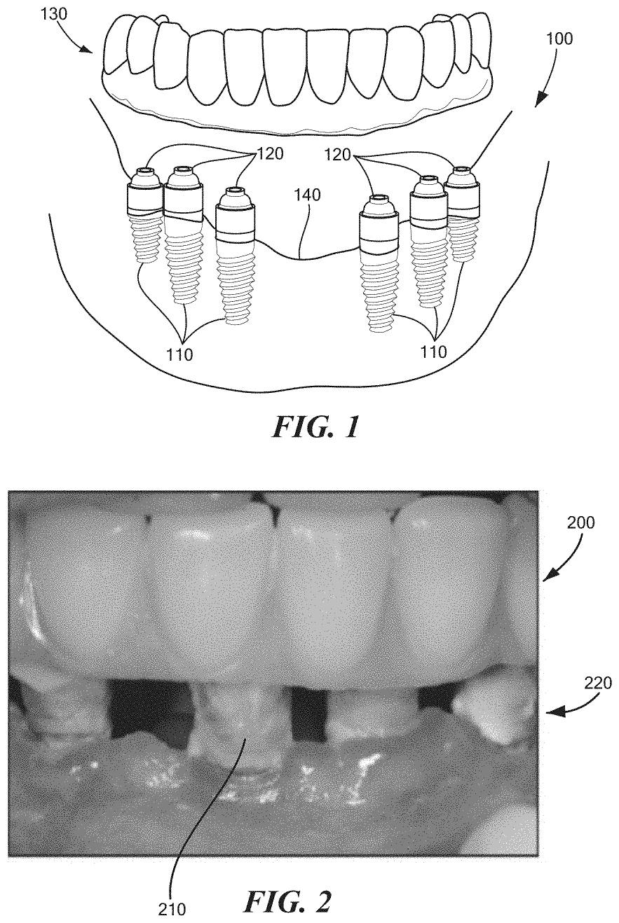

Referring to FIG. 1, an implant configuration 100 is illustrated with six implants or posts 110 that include abutments 120 that are fastened to the prosthesis 130. The abutment 120 may be partially exposed above the gum 140 as illustrated in FIG. 1, or may be mostly surrounded by the gum 140 (not shown). The implants 110 and abutments 120 are often composed of titanium or zirconium, as is the frame of the prosthesis 130. The implants 110 are screwed or otherwise anchored into the bone of the jaw. The abutments 120 are fastened to the implants 110, by threaded connections, anchors or other suitable fastenings. The abutments 120 are seated into copings (not shown) that are arranged along the framework of the prosthesis 130. The prosthesis 130 is fastened to the abutments 120 using screws that pass through the prosthesis copings and into the abutments 120. The recesses in the prosthesis where the screws pass through can be covered up with material that emulates tooth substance to form a physical as well as aesthetic seal for the screw holes.

Referring to FIG. 2, a photograph 200 illustrates the buildup of plaque 210 on the abutments 220. As discussed above, it is important to thoroughly clean the plaque 210 from these abutments 220 for good implant integrity and longevity. Current dental instruments used for natural teeth are sometimes composed of stainless-steel alloys. When used with abutments 220, these instruments can scratch the titanium abutments, which is undesirable. Some current dental instruments are composed of plastic to avoid scratching the titanium abutments, and are configured for use with natural teeth.

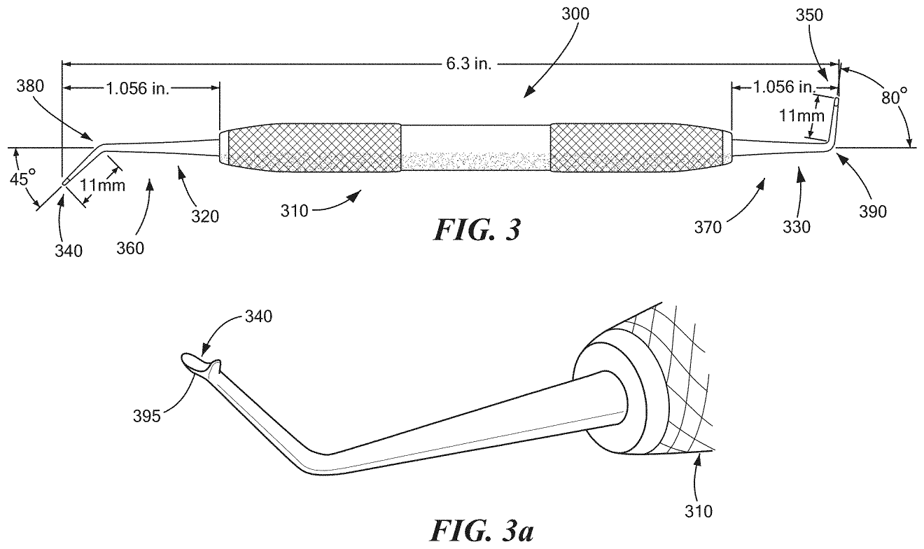

Referring to FIGS. 3 and 3a, a first example instrument that is useful for removing plaque from abutments is illustrated. The first instrument 300 is suitable for use in accessing the anterior abutment region, as well as the lower lingual area where calculus accumulation is prevalent. The first instrument 300 includes an elongated grip 310 with a shank 320, 330 on either end connected to a crescent shaped tip 340, 350, respectively. A first end 360 has a shank bend 380 of 45°, and a second end 370 has a shank bend 390 of 80°. The tip 340, 350 of each end includes a crescent shape 395, as shown in FIG. 3a, that defines a plane, the orthogonal to which shares a plane with the longitudinal axis of the elongated grip 310. The longitudinal axis of the grip is non-skew with the orthogonal of the plane defined by the crescent shaped tip 395. The crescent shape is described in greater detail below.

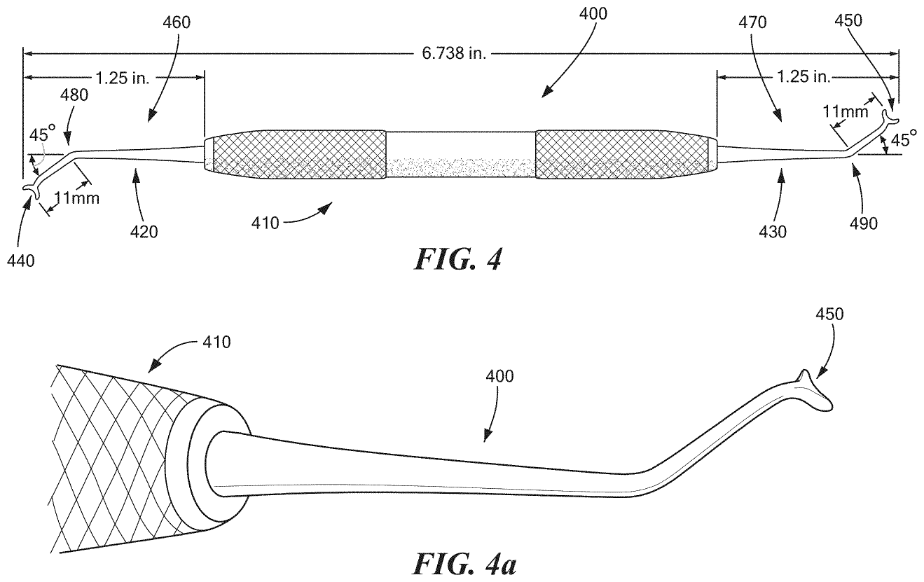

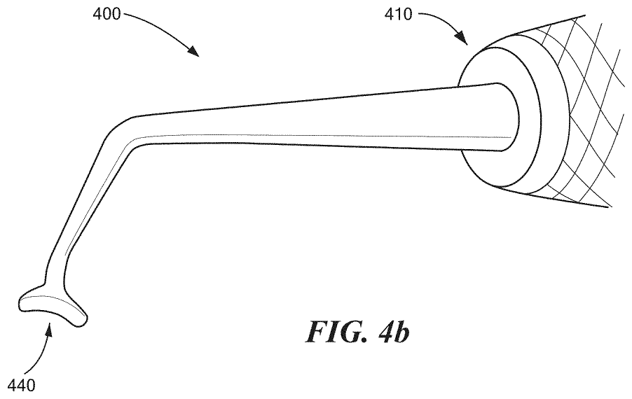

Referring to FIG. 4, a second example instrument that is useful for removing plaque from abutments is illustrated. The second instrument 400 is suitable for use in accessing the posterior abutment region as well as being suitable for buccal and lingual access. The second instrument 400 includes an elongated grip 410 with a shank on either end 420, 430 connected to a crescent shaped tip 440, 450, respectively. A first end 460 and a second end 470 each have a shank bend 480, 490, respectively, of 45°. Referring also to FIGS. 4a and 4b, each of the crescent shaped tips 440, 450 on the first and second ends 460, 470, respectively, of the second instrument 400 may be oriented in a different direction than those of the first instrument 300. For example, the crescent shaped tips 440, 450 may define distinct planes, the orthogonals to which may or may not share a plane with the longitudinal axis of the elongated grip 410. The longitudinal axis of the grip 410 is skew or non-skew with an orthogonal of the plane defined by the crescent shaped tip 450.

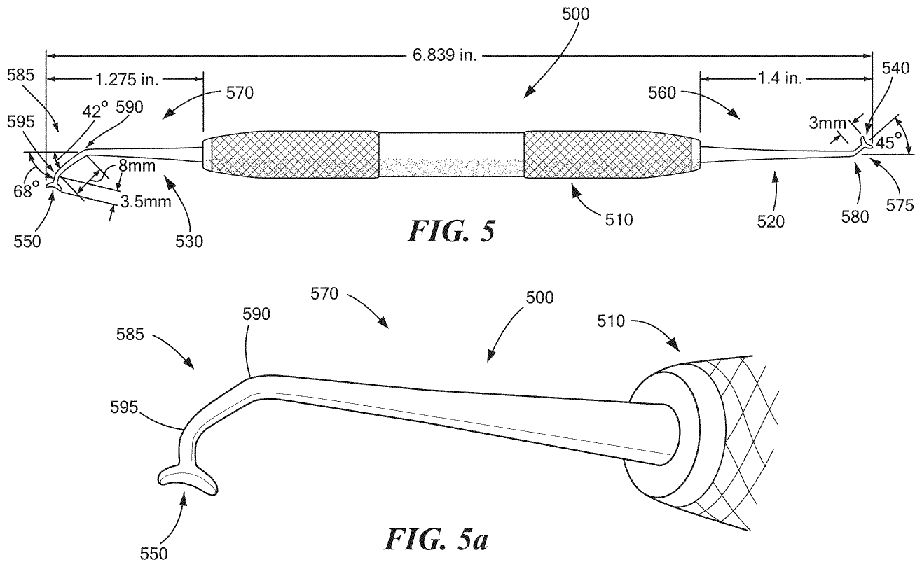

Referring to FIGS. 5 and 5a, a third example instrument that is useful for removing plaque from abutments is illustrated. The third instrument 500 is suitable for use in accessing the mesial and distal areas of the abutments from inside the mouth. The third instrument 500 includes an elongated grip 510 with a shank 520, 530 on either end 560, 570, respectively, connected to a crescent shaped tip 540, 550, respectively. A first end 560 has a shortened near-shank 575, in this example 3 mm, and a shank bend 580 of 45°. A second end 570 has a double bend 585, a first bend 590 of 42° and 8 mm from the first bend 590, a second bend 595 forming an angle with the grip longitudinal axis of 68°. As with the second instrument, the crescent shaped tips 540, 550 on the first and second ends 560, 570, respectively, of the third instrument 500 may define distinct planes, the orthogonals to which may or may not share a plane with the longitudinal axis of the elongated grip. The longitudinal axis of the grip may be skew or non-skew with the orthogonal of the plane defined by the crescent shaped tip.

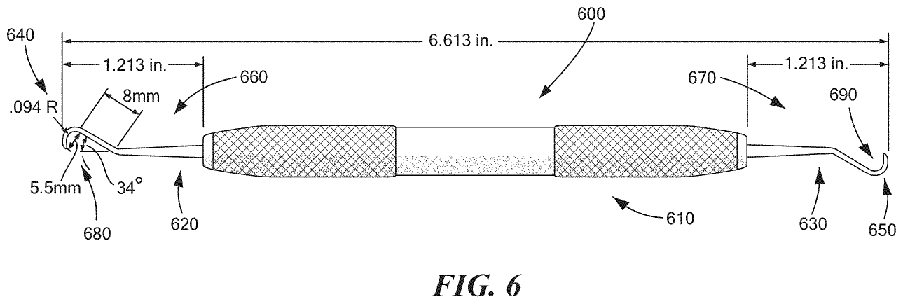

Referring to FIG. 6, a fourth example instrument that is useful for removing plaque from abutments is illustrated. The fourth instrument 600 is suitable for use in cantilever areas of the prosthesis. The fourth instrument 600 is also suitable for debridement in the flange area of the prosthesis. The fourth instrument 600 includes an elongated grip 610. Each end 660, 670 of the fourth instrument 600 includes a hook shape 640, 650, respectively, with a radius of curvature of 0.094 inches to form a distance across the hook shape of 5.5 mm. The shank 620, 630 is bent at an angle of 34° for each of the ends 660, 670, respectively, of the fourth instrument 600. The size and shape of the hook portion is specified for surrounding a portion of an abutment to permit cleaning of a larger portion of the abutment more quickly. The interior contour 680, 690 of the hook portion 640, 650, respectively, can be curved, ridged, a cylindrical section, e.g., flat, or any shape that contributes to desired engagement with the abutment and the interior of the hook. The hook portion may define a plane that may or may not be coplanar with the longitudinal axis of the instrument, e.g., skew or non-skew. All dimensions may be typical of both ends 660 and 670 of instrument 600.

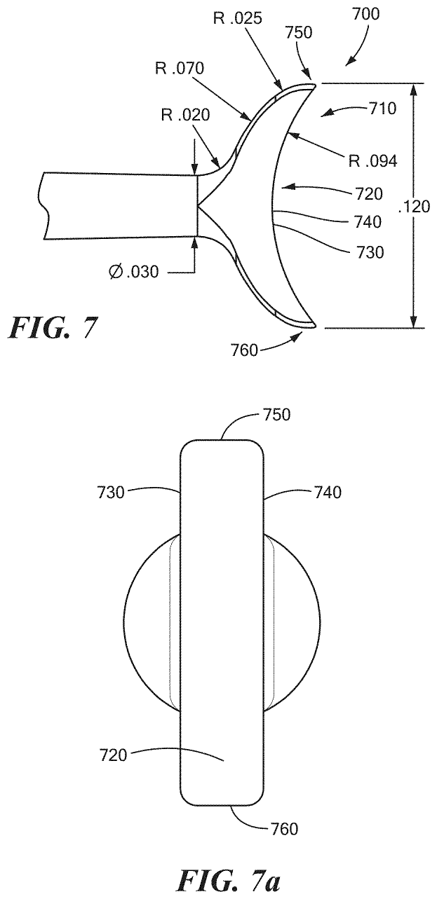

Referring to FIG. 7, a cutaway section of a plan view of an example crescent shaped tip 700 is illustrated. The radius of curvature of the concave portion 710 of the crescent shaped tip 700 is 0.094 inches. The surface and/or edges of the concave portion 710 can be curved. The concave portion 710 can be implemented, for example, as a surface, a ridge, e.g. a single edge, a cylindrical or conic section, e.g. two edges, skewed, e.g. in a slightly spiral aspect, be greater in length on one side of the shank than the other, have combinations of contours, such as curved, concave or convex, flat, or any desirable shape that can engage with the abutment for cleaning plaque and/or calculus. For example, FIGS. 3a, 4b and 5a show the interior or concave curve of the crescent shaped tip, 395, 450, and 550, respectively, as having a cylindrical section. This configuration for the crescent shaped tip 700 provides a surface 720 that cooperatively engages with the abutment for efficient cleaning. As shown in FIGS. 7 and 7a, the surface 720 may have two edges 730, 740 (shown as a curved line in FIG. 7) on either side of the surface 720, which can contribute to rapid removal of calculus, for example. The thickness between the two surfaces 730 and 740 may range from about 0.010 inches to about 0.040 inches. Preferably, the thickness is about 0.028 inches. The two edges 730, 740 may have the same or different radius of curvature, and may have different degrees of transition, e.g. one edge may be smoother or sharper than the other. The different radii of curvature (not shown) or different degrees of transition (not shown) of the edges 730, 740 may be useful for removing plaque and/or calculus from different areas. The crescent shape may have a thickness that decreases in the direction closer to the tips or ends 750, 760 of the crescent shape (not shown). The tips or ends 750, 760 of the crescent shape may be the thinnest part of the crescent shape, and may be useful for cleaning in small areas, or for removing plaque and/or calculus from difficult areas, such as where the abutment meets the coping and frame of the prosthesis.

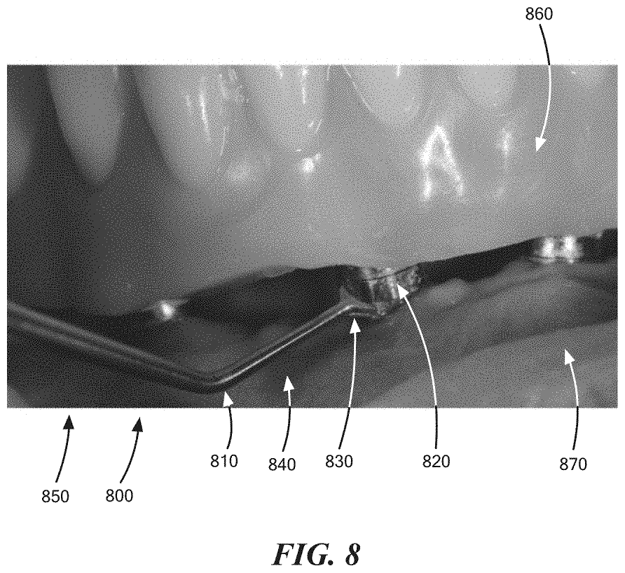

Referring to FIG. 8, a photograph 800 illustrates the use of the first instrument 810 in an anterior region of an abutment 820 to clean plaque from the abutment 820. As shown, the crescent shaped tip 830 engages with the abutment 820 and is moved back and forth along a longitudinal axis of the abutment 820, as well as in a circumferential direction around the abutment 820 to remove plaque. The shank 840 of the end 850 of the first instrument 800 is configured to be thin enough to access the anterior of the abutment 820. For example, the shank 840 can fit between the prosthesis 860 and the gum 870 of the patient.

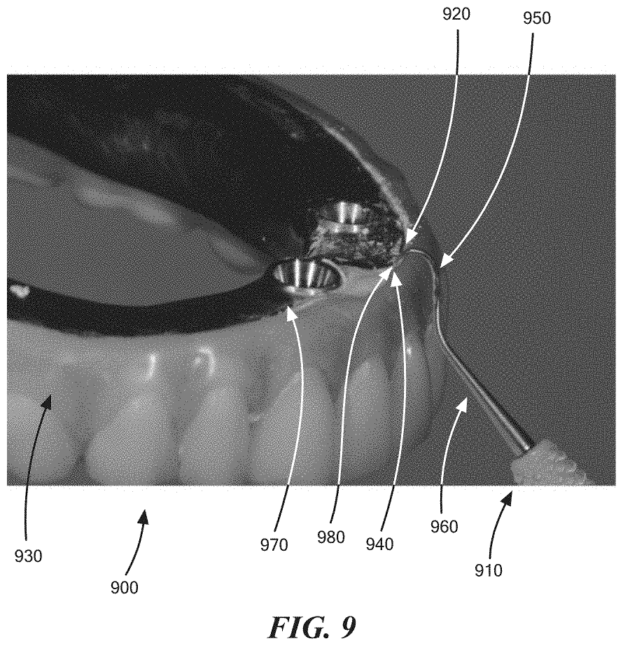

Referring to FIG. 9, a photograph 900 illustrates the use of the fourth instrument 910 on a lip 920 of the framework of the prosthesis 930. A tapered point portion 980 of the tip 940 of the hook 950 of the fourth instrument 910 is used to disrupt the plaque or calculus on the lip 920 of the prosthesis 930. The radius of curvature of the hook 950 and separation of the tip 940 from the shank 960 provide sufficient clearance for the hook 950 to be inserted between the gum 970 and prosthesis 930 of the patient and rotated to engage with the lip 920 of the prosthesis 930.

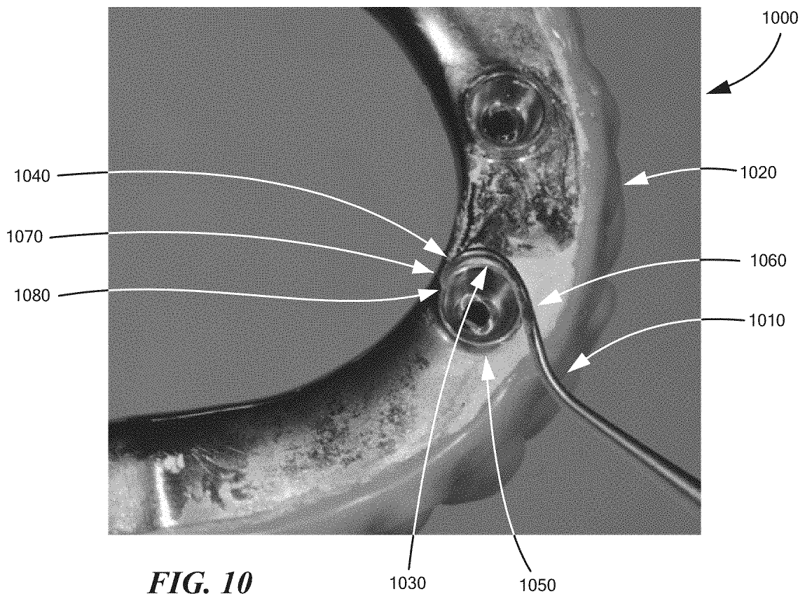

Referring to FIG. 10, a photograph 1000 illustrates the use of the fourth instrument 1010 on a coping 1050 of the framework of the prosthesis 1020. As noted in the photograph, the interior contour 1030 of the hook 1040 follows the diameter of the coping 1050 as shown to permit a larger portion of the coping 1050 to be rapidly cleaned by moving the hook portion 1040 back and forth in a direction along the longitudinal axis of the coping 1050, as well as by rotating the hook 1040 in a circumferential direction around the coping 1050. As noted, the tapered point portion 1080 of the tip 1070, the hook 1040 and the shank 1060 of the hook portion 1040 are thin enough to extend between the prosthesis 1020 and the gum of the patient (not shown).

The hook portion 1040 of the fourth instrument 1010 can also be used to clean the cantilever portion of the prosthesis framework 1020. The cantilever portion (not shown) extends to the posterior of the patient's mouth. The cantilever is a portion of the prosthesis near the terminal ends of a full mouth prosthesis. The length of the cantilever can be up to 15-20 mm. The hook portion 1040 configuration can reach around the prosthesis 1020 to clean the framework of the cantilever portion of the prosthesis.

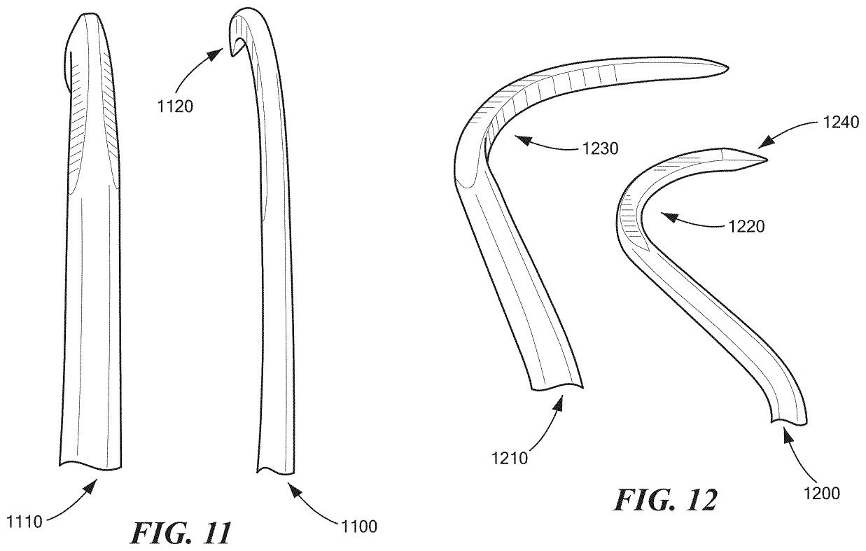

Referring to FIGS. 11 and 12, examples of the fourth instrument 1100, 1200, respectively, are shown next to current implant hygiene tools 1110, 1210, respectively. As can be seen, the thickness of the fourth instrument 1100, 1200 is significantly less than that of the current tool 1110, 1210, respectively, having, for example, one third to one half the thickness. The smaller thickness dimension of the fourth instrument 1100, 1200 permits easier access to the often small spacing between the prosthesis and gum of the patient. For example, the fourth instrument 1100, 1200 can slide or fit between the prosthesis and gum of the patient, to permit the hook portion to wrap around a portion of an abutment for easier and more efficient cleaning. As seen in FIG. 12, the inner radius of curvature 1220 of the fourth instrument 1200 is significantly smaller than that of the inner radius of curvature 1230 of the current tool 1210, which enhances the capability of the fourth instrument 1200 to be more efficient and productive as a cleaning tool. As can further be seen, the fourth instrument 1100, 1200 has a tapered point portion 1120, 1240, tapered sharply near the tip at the end of the curvature 1220, as compared to current implant hygiene tools 1110, 1210 that taper along the length of the curvature 1230 but do not taper sharply near the tip. In an example of the fourth instrument, a tapered point portion 1120, 1240 begins sharply tapering at approximately 1 mm from the end of the tip. The thickness of the portion of the tip where the tapering begins may have a thickness of between about 0.010 inches to about 0.050 inches, and preferably has a thickness of about 0.032 inches.

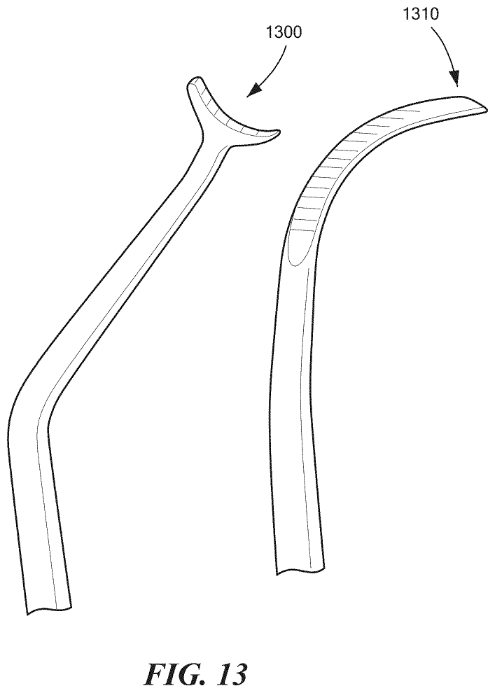

Referring to FIG. 13, a similar advantage to the crescent shaped tip 1300 is observed over conventional hygiene tools 1310. The crescent tip 1300 can directly engage with an abutment to permit effective cleaning, whereas the conventional tool 1310 would be applied at a number of different angles or aspects to engage the surface of the abutment around the circumference.

The instrument shanks and/or tips can be composed of titanium or zirconium as examples. Portions of the instruments, such as the elongated grip or shank can be composed of stainless steel alloys, including those recommended or designed for dental usage. Any suitable type of material can be used for the instrument grips and shanks, including plastics, rubbers, ceramics and corrosion resistant metals and alloys, to name a few materials. The instruments can be constructed by securing a manufactured end into each end of the elongated grip. Any of the instruments can be constructed with a single side, e.g., a single tip. The instruments can be constructed and configured for sterilization processes, including but not limited to autoclaving, without detriment to their structure or usability. The securement can be by adhesive, heat shrink, detents or any other suitable fastening configuration. The elongated grip is composed of a plastic or rubber that facilitates a non-slip grip by the user. The grip may be knurled to provide an improved grip for the user.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known processes, structures, and techniques have been shown without unnecessary detail to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional stages or functions not included in the figure.

Having described several example configurations, various modifications, alternative constructions, and equivalents may be used without departing from the spirit of the disclosure. For example, the above elements may be components of a larger system, wherein other structures or processes may take precedence over or otherwise modify the application of the invention. Also, a number of operations may be undertaken before, during, or after the above elements are considered. Accordingly, the above description does not bound the scope of the claims.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

What is claimed is:

1. A dental hygiene instrument, comprising:
a tip on an end of a shank, the tip including an arcuate portion transverse to a longitudinal axis of the end of the shank.

2. The instrument of claim 1, comprising the arcuate portion of the tip being convex with respect to the end of the shank.

3. The instrument of claim 2, further comprising opposing lateral extents equidistant from the end of the shank.

4. The instrument of claim 1, comprising the arcuate portion of the tip being concave with respect to the end of the shank and extending in a segment of a circle.

5. The instrument of claim 1, wherein the tip is crescent shaped.

6. The instrument of claim 1, wherein the tip is hook shaped.

7. The instrument of claim 1, wherein the tip includes a portion with a radius of curvature suitable for engaging a curvature of an abutment for a dental implant.

8. The instrument of claim 7, wherein the radius of curvature is 0.094 inches.

9. The instrument of claim 7, wherein the tip includes a tapered point portion.

10. A dental hygiene instrument, comprising:
a shank including a first end and a second end;
the shank including a tip on the first end, the tip including an arcuate portion transverse to a longitudinal axis of the first end of the shank; and
the shank including a bend between the first end and the second end.

11. The instrument of claim 10 wherein the portion of the tip is crescent shaped.

12. The instrument of claim 10, wherein the portion of the tip is hook shaped.

13. The instrument of claim 10, wherein the tip includes a portion with a radius of curvature suitable for engaging a curvature of an abutment for a dental implant.

14. The instrument of claim 10, wherein the bend ranges between about 40 degrees and about 50 degrees.

15. The instrument of claim 10, wherein the bend ranges between about 75 degrees and 85 degrees.

16. The instrument of claim 10, further comprising a hook portion between the bend and the tip.

17. The instrument of claim 10, wherein the thickness of the tip ranges between about 0.010 inches to about 0.040 inches.

18. A dental hygiene instrument, comprising:
a grip with a first shank on a first end and a second shank on a second end, the first shank and the second shank extending along the longitudinal axis of the grip;
the first shank and the second shank connected to a first tip and a second tip, respectively;
the first shank including a first bend between the grip and the first tip and the second shank including a second bend between the grip and the second tip; and
wherein the first tip including an arcuate portion transverse to the longitudinal axis of the grip.

19. The instrument of claim 18, wherein the second tip including an arcuate portion transverse to the longitudinal axis of the grip.

20. The instrument of claim 18, wherein the first tip including a portion with a radius of curvature suitable for engaging a curvature of an abutment for a dental implant.

21. The instrument of claim 18, wherein the arcuate portion of the first tip is crescent shaped.

22. The instrument of claim 19, wherein the first tip and the second tip including a portion with a radius of curvature suitable for engaging a curvature of an abutment for a dental implant.

23. The instrument of claim 19, wherein the arcuate portion of the first tip and the arcuate portion of the second tip are crescent shaped.

24. The instrument of claim 19, wherein the arcuate portion of the first tip is crescent shaped and the arcuate portion of the second tip is hook shaped.

25. The instrument of claim 18, wherein the first bend and the second bend are about 45 degrees.

26. The instrument of claim 18, wherein the first bend ranges between about 40 degrees and about 50 degrees and the second bend ranges between about 75 degrees and 85 degrees.

27. The instrument of claim 18, wherein the first bend includes a double bend between the grip and the first tip, the double bend including a first portion bent away from the longitudinal axis of the grip and a second portion bent further away from the longitudinal axis of the grip.

28. The instrument of claim 27, wherein the double bend includes a first portion bent at an angle of about 42 degrees from the longitudinal axis of the grip and a second portion bent at an angle of about 68 degrees from the from the longitudinal axis of the grip.

29. A method for cleaning a dental implant, comprising:
applying a tip of a dental hygiene instrument to an abutment of the dental implant,
wherein the tip includes an arcuate portion transverse to an axis of the end of the shank.

30. The method of claim 29, wherein the tip includes a portion with a radius of curvature suitable for engaging a curvature of the abutment.
